(19) United States
(12) Patent Application Publication
(10) Pub. No.: US 2023/0413169 A1
(43) Pub. Date: Dec. 21, 2023

(54) Prioritizing a Private Enterprise Deployed Cellular Network over a Wi-Fi Network

(71) Applicant: Apple Inc., Cupertino, CA (US)

(72) Inventors: Raj S CHAUGULE, Santa Clara, CA (US); Ajoy K. SINGH, Milpitas, CA (US); Henri S. BERGER, Los Altos, CA (US); Li LI, Saratoga, CA (US); Nai Tao CUI, Santa Clara, CA (US)

(21) Appl. No.: 18/337,591

(22) Filed: Jun. 20, 2023

Related U.S. Application Data
(60) Provisional application No. 63/366,712, filed on Jun. 21, 2022.

(51) Int. Cl. H04W 48/18; H04W 8/20

(52) U.S. Cl. CPC H04W 48/18; H04W 8/20

(57) ABSTRACT

A user equipment (UE) is configured to determine that a private enterprise deployed cellular network is available, determine that a Wi-Fi network is available at a same time as the private enterprise deployed cellular network and prioritize connection to the private enterprise deployed cellular network over the Wi-Fi network based on one or more conditions.

### PRIORITY CLAIM/INCORPORATION BY REFERENCE

This application claims priority to U.S. Provisional Application Ser. No. 63/366,712 entitled “Prioritizing a Private Enterprise Deployed Cellular Network over a Wi-Fi Network,” filed on Jun. 21, 2022, the entirety of which is incorporated by reference herein.

### BACKGROUND

Citizens Broadband Radio Service (CBRS) is 150 MHz of spectrum (from 3.55 to 3.7 GHz) in the 3.5 GHz band (“Band 48”). CBRS may be used to deploy private cellular networks with small but concentrated deployments. A CBRS network may be deployed by traditional cellular providers, private enterprises, universities, cities or municipalities, etc. The CBRS network is an alternative to Wi-Fi networks and may offer certain advantages over Wi-Fi networks. These advantages may include wider and stronger network strength, a means to transport sensitive data, the avoidance of Wi-Fi related issues such as “listen before talk,” high latency, and congestion. However, standard user equipment (UE) is designed to prioritize Wi-Fi networks over cellular networks. Thus, when a UE is in an area that includes both Wi-Fi and CBRS coverage, the UE will prioritize Wi-Fi. There is a need for the UE to prefer the CBRS network.

### SUMMARY

Some exemplary embodiments are related to a processor of a user equipment (UE) configured to determine that a private enterprise deployed cellular network is available, determine that a Wi-Fi network is available at a same time as the private enterprise deployed cellular network and prioritize connection to the private enterprise deployed cellular network over the Wi-Fi network based on one or more conditions.

Other exemplary embodiments are related to a user equipment (UE) having a transceiver configured to communicate with one or more networks and a processor communicatively coupled to the transceiver and configured to determine that a private enterprise deployed cellular network is available, determine that a Wi-Fi network is available at a same time as the private enterprise deployed cellular network and prioritize connection to the private enterprise deployed cellular network over the Wi-Fi network based on one or more conditions.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows a general state engine implemented by the UE to prioritize a CBRS network over a wireless local area network (Wi-Fi) according to various exemplary embodiments.

FIG. 4 shows an overview of a use case for the UE to determine a priority between the CBRS network and the Wi-Fi according to various exemplary embodiments.

FIG. 5 shows a flow for the UE to make the determination as to whether connection to the CBRS network or the Wi-Fi should be prioritized according to various exemplary embodiments.

FIG. 6 shows an exemplary call flow for the state engine implemented by the SIS engine to enter the outrank state according to various exemplary embodiments.

### DETAILED DESCRIPTION

The exemplary embodiments may be further understood with reference to the following description and the related appended drawings, wherein like elements are provided with the same reference numerals. The exemplary embodiments relate to prioritizing a cellular network (e.g., a CBRS network) over a Wi-Fi network.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are described with reference to a CBRS network. As described above, CBRS primarily refers to a technology which is deployed only in the United States on Band 48 (B48 or N48) and use CBRS shared public land mobile networks (PLMN) 315/0100n. However, it should be understood that the exemplary embodiments may be applied to any private enterprise deployed cellular network. For example, there are current deployments of private enterprise cellular networks that operate on non-Band 48 and networks that could be deployed on other PLMNs such as Mobile Country Code (MCC)=999 instead of CBRS. These deployments may be in the US or in any other country or territory in the world. Thus, the term CBRS as used in describing the exemplary embodiments should be understood to include any private enterprise deployed cellular network. In addition, it should be understood that private enterprise in the context of this disclosure may include public entities such as cities, municipalities or any other government entity or non-government entity that is controlled or affiliated with a local, state, provincial, or national government.

The exemplary embodiments are also described with regard to a CBRS network that implements fifth generation (5G) new radio (NR) radio access technology (RAT). However, those skilled in the art will understand that the CBRS may implement any cellular RAT such as Long Term Evolution (LTE) or further evolutions of the cellular standards (e.g., 6G technologies).

The exemplary embodiments describe various conditions and manners for prioritizing a CBRS network over a Wi-Fi network. These conditions may include that the UE is capable of operating in the frequency range of the CBRS network, the UE has a SIM card for the CBRS network, the UE is located in the coverage area of the CBRS network and the signal strength of the CBRS network is sufficiently strong. Additional conditions for prioritizing the CBRS network over Wi-Fi networks are described below, including the manners of monitoring the conditions and changing a state of the UE based on the conditions.

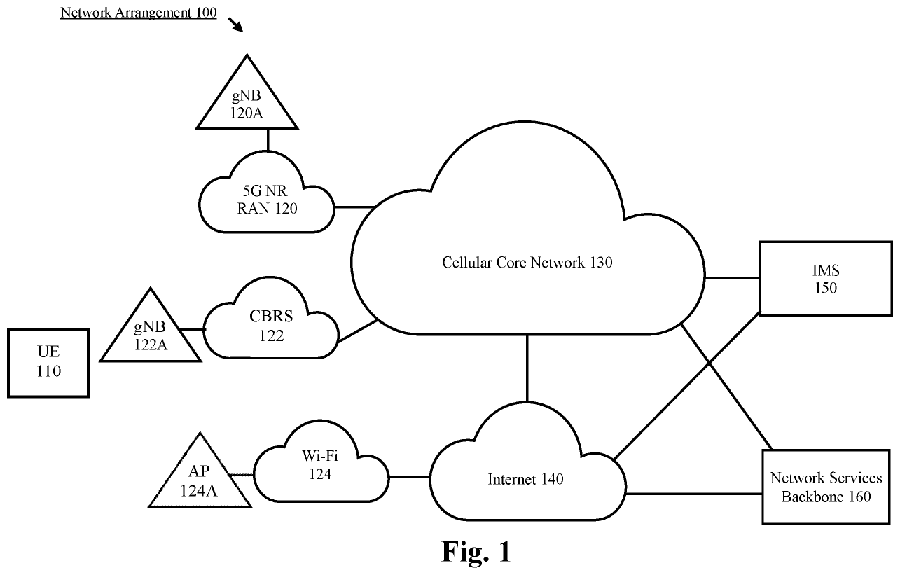

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables (e.g., head mounted display (HMD), AR glasses, etc.), Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the networks with which the UE 110 may wirelessly communicate is a 5G NR radio access network (RAN) 120, a CBRS network 122 and a wireless local area network (Wi-Fi) 124. However, the UE 110 may also communicate with other types of networks (e.g., 5G cloud RAN, a next generation RAN (NG-RAN), a long term evolution (LTE) RAN, a legacy cellular network, etc.) and the UE 110 may also communicate with networks over a wired connection. With regard to the exemplary embodiments, the UE 110 may have an appropriate chipset to communicate with the NR RAN 120, CBRS network 122 and/or Wi-Fi 124.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. In the example of FIG. 1, a next generation Node B (gNB) 120A is shown as a base station of the 5G NR RAN 120.

The CBRS network 122 may also be a cellular based network that may be deployed by an entity, e.g., traditional cellular providers, other private enterprises, universities, cities or municipalities, etc. However, as described above, in contrast to the 5G NR RAN 120, the CBRS network 122 is typically a small but concentrated deployment, e.g., on an enterprise or university campus, at an airport, in a store, etc. Similar to the 5G NR RAN 120, the CBRS network 122 may also include cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. In the example of FIG. 1, a gNB 122A is shown as a base station of the CBRS network 122.

The Wi-Fi 122 is a Wi-Fi based network that may be deployed by an entity. Those skilled in the art will understand that the Wi-Fi 122 may include any type of network that is compliant with the IEEE 802.11xx standards or any other type of non-cellular wireless network. The UE 110 may connect to the Wi-Fi 122 via access points (APs), wireless routers, wireless hubs, wireless bridges, wireless switches, etc. that are configured to send and receive traffic from UEs that are equipped with the appropriate Wi-Fi chip set. In the example of FIG. 1, an AP 124A is shown as an access point for the Wi-Fi 124.

In the network arrangement 100, the UE 110 may connect to the 5G NR-RAN 120 via the gNB 120A or to the CBRS network 122 via the gNB 122A. Those skilled in the art will understand that any association procedure may be performed for the UE 110 to connect to the 5G NR-RAN 120 or the CBRS network 122. For example, as discussed above, the 5G NR-RAN 120 may be associated with a particular cellular provider where the UE 110 and/or the user thereof has a contract and credential information (e.g., stored on a subscriber identity module (SIM) card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). Similarly, the CBRS network 122 may be associated with the entity that deployed or administrates the CBRS network 122. The UE 110 and/or the user thereof may have a contract and credential information (e.g., stored on a SIM card). Upon detecting the presence of the CBRS network 122, the UE 110 may transmit the corresponding credential information to associate with the CBRS network 122. More specifically, the UE 110 may associate with a specific base station (e.g., gNB 122A).

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

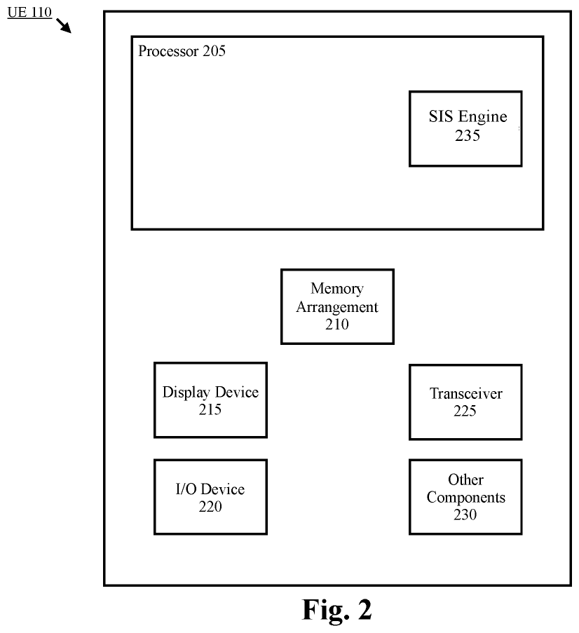

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute multiple engines of the UE 110. For example, the engines may include a Smart Interface Selection (SIS) engine 235. The SIS engine 235 may perform a variety of operations related to determining whether to prioritize the CBRS network 122 over the Wi-Fi 124. The operations may include, but are not limited to, monitoring predetermined conditions related to prioritizing the CBRS network 122 over the Wi-Fi 124.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

The SIS engine 235 performs operations to determine when one networking physical interface should take a higher priority than other interfaces to provide a better networking experience for the user. In the examples provided below, the SIS engine 235 will determine when the CBRS network 122 is to take priority over the Wi-Fi 124. As will be described in greater detail below, the SIS engine 235 considers several inputs from the UE 110 to decide when to prioritize connection to the CBRS network 122 over the Wi-Fi 124. However, prior to describing the specific inputs that may be used, a description of the general state engine implemented by the SIS engine 235 is provided.

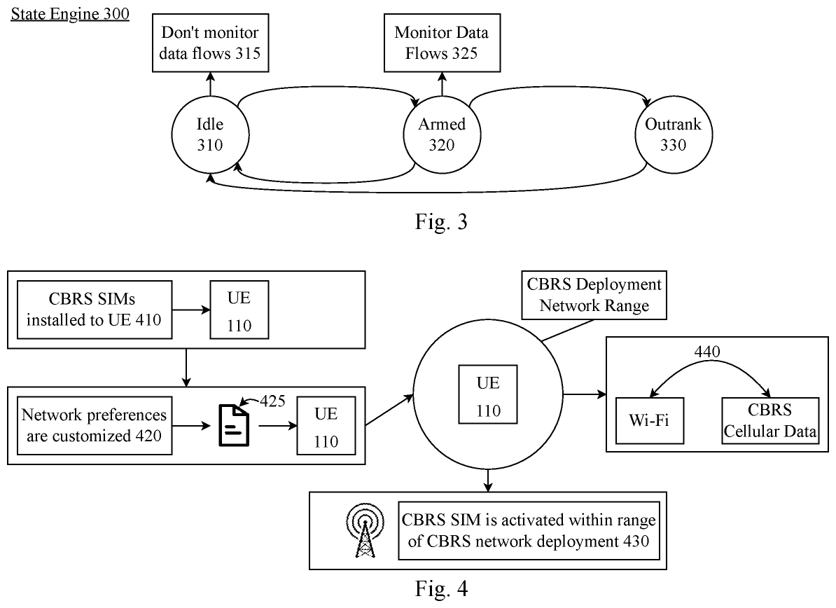

FIG. 3 shows a general state engine 300 implemented by the UE 110 to prioritize the CBRS network 122 over the Wi-Fi 124 according to various exemplary embodiments. The state engine 300 has three states: idle 310, armed 320 and outrank 330. Those skilled in the art will understand that while the exemplary state engine 300 has three (3) states, the state engine is not limited to three states. Any number of states may be defined for the state engine and any set of conditions related to the prioritizing of the CBRS network 122 over the Wi-Fi network 124 may be associated with these further defined states.

The idle state 310 is where the state engine 300 remains when a set of conditions of the operation of the UE 110 have not been met. Examples of these conditions are provided below. When in the idle state 310, the SIS engine 235 will not monitor data flows 315 of the UE 110 because the underlying conditions of prioritizing the CBRS network 122 have not been met. When the set of conditions are satisfied, the state engine 300 will transition from the idle state 310 to the armed state 320 (described in greater detail below). However, as shown in FIG. 3, this transition may include a delay. This may be based on the fact that there may be other UEs in a particular environment such as, for example, a sporting event. The UEs should not be allowed to self-synchronize, where many may transfer from Wi-Fi to cellular and then back again en masse. To prevent this, a random timing delay is introduced to allow the various networks to accommodate the switching of multiple devices.

The armed state 320 is when the state engine 300 starts monitoring networking data flows 325 and starts processing event-driven indications that the CBRS network 122 connection should outrank the Wi-Fi 124. Again, examples of these event driven indications are provided below. When the conditions for prioritizing the CBRS network 122 over the Wi-Fi 124 are satisfied, the state engine 300 will transition from the armed state 320 to the outrank state 330 (described in greater detail below). However, when in the armed state 320, the SIS engine 235 will continue to monitor the set of conditions that are monitored in the idle state 310. When any of these conditions are no longer satisfied, the state engine 300 will transition from the armed state 320 back to the idle state 310.

The outrank state 330 is when the state engine 300 indicates the ranking of the Wi-Fi 124 is to be lowered such that the CBRS network 122 takes priority over the Wi-Fi 124. That is, when the networking data flows 325 and event-driven indications indicate that the CBRS network 122 takes priority over the Wi-Fi 124, the UE 110 will connect to the CBRS network 122 and exchange data using the cellular connection to the CBRS network 122. In the exemplary embodiments, the determination to transition from the armed state 320 to the outrank state 330 is based on a determination of cell eligibility, Wi-Fi eligibility and device eligibility. The conditions that satisfy each of these eligibility factors will be described in greater detail below. Once in the outrank state 330, the state engine 300 continues monitoring the system to decide if the recommendation to outrank should be rescinded.

It should be understood that while the conditions of cell eligibility, Wi-Fi eligibility and device eligibility are described as a set of conditions for transitioning the state engine 300 from the armed state 320 to the outrank state 330, these same conditions may be tested and used to transition the state engine 300 from the idle state 310 to the armed state 320. For example, the cell eligibility, Wi-Fi eligibility and device eligibility conditions may be tested when in the idle state 310 and then re-tested when in the armed state 320.

FIG. 4 shows an overview of a use case 400 for the UE 110 to determine a priority between the CBRS network 122 and the Wi-Fi 124 according to various exemplary embodiments. In 410, it is determined if the UE 110 includes a SIM that allows access to the CBRS network 122. This may be considered a prerequisite as to whether the SIS engine 235 is instantiated on the UE 110. That is, if the UE 110 does not have a SIM allowing access to the CBRS network 122, the UE 110 does not need to execute the SIS engine 235 for the purposes of prioritizing the CBRS network 122 because the UE 110 is incapable of connecting to the CBRS network 122.

In 420, the UE 110 receives the network preferences 425 from the user. Typically, the user of the UE 110 has multiple manners of setting the network preferences. In a first example, the operating system of the UE 110 (e.g., iOS, Android, etc.) allows a user to set the network preferences for each application that is installed on the UE 110. This network preference may be whether the application is allowed to use cellular data or is limited to using Wi-Fi data. In a second example, each application may have a setting that allows a user to set the network preferences for the application. For example, different features of an application, e.g., downloading, uploading, streaming, etc., may have settings that allow the user to select whether cellular data should be used for one or more of these features. Those skilled in the art will understand that there may be other manners of setting network preferences and the above manners are only provided as examples. The SIS engine 235 may consider the user network preferences when making the determination regarding the priority of the CBRS network 122 and the Wi-Fi 124.

It should be understood that the above described network preferences are related to the type of data that may be used for individual applications and these preferences may be used by the SIS engine 235 when making the determination regarding the priority of the CBRS network 122 and the Wi-Fi 124. However, there is a more fundamental preference that the user may make as prerequisite as to whether the SIS engine 235 is instantiated on the UE 110. That is, whether the user would like to prioritize the CBRS network 122 over the Wi-Fi 124, when available. If the user has not made such a preference, the UE 110 does not need to execute the SIS engine 235 for the purposes of prioritizing the CBRS network 122. Furthermore, there may be user network preferences which a lower networking stack considers when allowing data to flow or not as cellular data. For example, SIS engine 235 may enter the outrank state 235 even if the user application cannot take advantage of cellular data, e.g., there is a user network preference that disallows cellular data for an application or certain operations of an application.

In 430, it may be considered that the UE 110 has moved into the coverage area of the CBRS network 122 and the corresponding SIM card has been activated allowing the UE 110 to connect to the CBRS network 122, if desired. This may be considered a condition for the SIS engine 235 to transition from the idle state 310 to the armed state 320. As described above, if the UE 110 has a SIM allowing connection to the CBRS network 122 and the user has set the preferences to prioritize the CBRS network 122 over the Wi-Fi 124, when available, the SIS engine 235 will be instantiated on the UE 110 and in the idle state 310. When the conditions for transitioning from the idle state 310 to the armed state 320 are satisfied, the SIS engine 235 will transition to the armed stated 320 and begin monitoring the data flows 325 for the purposes of prioritizing the CBRS network 122.

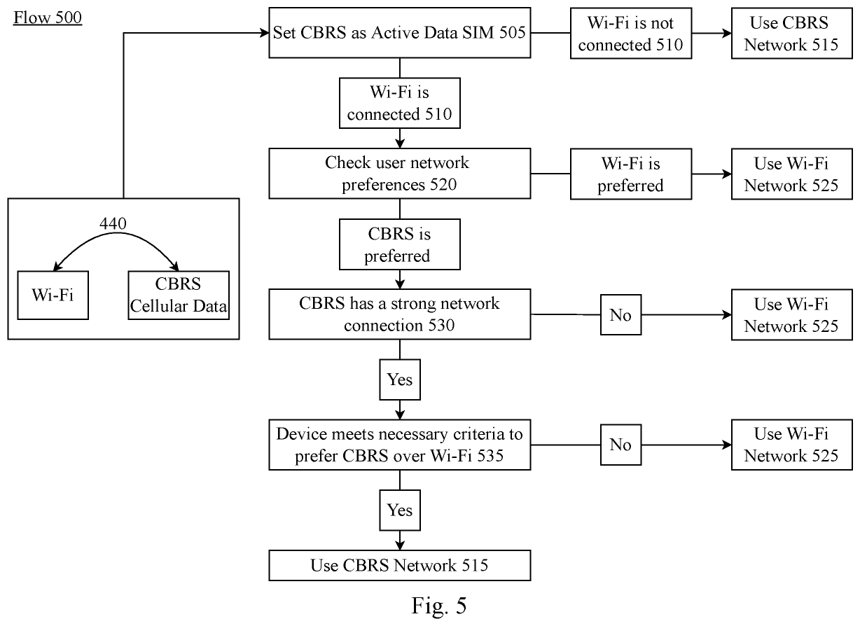

In 440, while the UE is in the coverage area of the CBRS network 122, the UE 110 will decide as to whether connection to the CBRS network 122 or the Wi-Fi 124 should be prioritized. An overview of this determination process will be provided with reference to FIG. 5.

FIG. 5 shows a flow 500 for the UE 110 to make the determination as to whether connection to the CBRS network 122 or the Wi-Fi 124 should be prioritized according to various exemplary embodiments. As described above, the flow 500 is performed when the UE 110 has a SIM that allows the UE 110 to connect to the CBRS network 122, the user has set of preference of preferring the CBRS network 122 over the Wi-Fi 124 and the UE 110 is within the coverage area of the CBRS network 122.

In 505, it is determined whether the SIM for the CBRS network 122 has been set as the active data SIM. As described above, the UE 110 may also have one or more SIM(s) that allow the UE 110 to connect to other cellular networks, e.g., 5G NR RAN 120. The user preferences may be set to use another SIM for connection to another cellular network even when a CBRS network is available. Thus, in 505, the UE 110 verifies that the user preference is to use the cellular services of the CBRS network 122, when available, based on the user preference of the CBRS SIM as the active data SIM. In 505, it may be considered that the preference is to use the cellular services of the CBRS network 122, when available.

In 510, it is determined whether the Wi-Fi 124 is connected. It should be understood that Wi-Fi 124 may be any of multiple Wi-Fi networks. For example, there may be multiple Wi-Fi networks that are deployed in the coverage area of the CBRS network 122 and the Wi-Fi 124 may represent any of these Wi-Fi networks. If the Wi-Fi 124 is not connected in 510, then in 515 the UE 110 will connect to the CBRS network 122 because the SIM for the CBRS network 122 has been set as the active data SIM.

If the Wi-Fi 124 is connected in 510, then in 520 the UE 110 will determine the network preferences that have been selected by the user. As described above with respect to 420, a user of the UE 110 may set network preferences, e.g., via the operating system of the UE 110 or in the individual settings of each application. In this example, the network preferences may be whether the user allows cellular data for an application. As also described above, the UE 110 will attempt to honor the user preference selection when making the priority decision between the CBRS network 122 and the Wi-Fi 124. If the network preference is Wi-Fi and the Wi-Fi 124 is connected, the UE 110 will remain connected to and use 525 the Wi-Fi 124 when in the coverage area of the CBRS network 122.

If the network preference is the CBRS network 122, in 530 the UE 110 will determine if a sufficiently strong connection may be made to the CBRS network 122. This determination may be made using any of one or more cellular connection metrics, e.g., Received Signal Strength Indicator (RSSI), Reference Signal Received Power (RSRP), Reference Signal Received Quality (RSRQ), Block Error Rate (BLER), etc. If the cellular connection is not of a sufficient quality and the Wi-Fi 124 is connected, the UE 110 will remain connected to and use 525 the Wi-Fi 124 when in the coverage area of the CBRS network 122.

If the cellular connection is of a sufficient quality, in 535 the UE 110 will determine whether all the conditions to prefer the CBRS network 122 over the Wi-Fi 124 are satisfied. Example conditions are discussed in greater detail below. If the conditions are not satisfied, the UE 110 will remain connected to and use 525 the Wi-Fi 124 when in the coverage area of the CBRS network 122. If the conditions are satisfied, the UE 110 connect to and use 515 the CBRS network 122 when in the coverage area of the CBRS network 122.

As described above, the determination to transition from the armed state 320 to the outrank state 330 (e.g., prioritize the CBRS network 122 over the Wi-Fi 124) is based on a determination of cell eligibility, Wi-Fi eligibility and device eligibility. Some example conditions of these eligibility factors were described above with reference to FIG. 5. The following will expand on these examples and provide additional examples.

With respect to cell eligibility, a first example condition is that the CBRS network 122 must be actively used. For example, is the gNB 122A in active use and will the UE 110 be able to connect to the gNB 122A (or other base station) of the CBRS network 122. Those skilled in the art will understand that even if the UE 110 has an eligible SIM and is able to operate on the CBRS frequency, there may be reasons why the UE 110 cannot connect to the gNB 122A, e.g., the gNB 122A is overloaded, the gNB 122A is access barred for some reason, etc. Thus, the SIS engine 235 will verify the gNB 122A in active use and the UE 110 will be able to connect to the gNB 122A as a condition of cell eligibility.

A second example of cell eligibility is that the CBRS network 122 is marked with an expense flag. For example, the expense flag may indicate that the CBRS network 122 is “inexpensive” (e.g., comparatively less expensive that other cellularly based networks). Typically, cellular data is more expensive than Wi-Fi data, this is especially true for data exchanged on LTE or earlier legacy networks. The UE 110 may store information that indicates the relative expense of various networks. However, since there is little or no cost for the UE 110 to use the CBRS network 122, cellular data that is exchanged via the CBRS network 122 may be marked as inexpensive, whether that cellular data is exchanged on a 5G network or any earlier iterations of cellular networks. The expense flag information that the CBRS network 122 is considered an inexpensive option may be stored in the UE 110 and used by the SIS engine 235 to verify that CBRS data is marked as inexpensive as a condition of cell eligibility.

A third example of cell eligibility is that the CBRS cell quality is strong. Examples of this condition were described above with reference to operation 530, e.g., measuring RSSI, RSRP, RSRQ, BLER, etc. This determination may be made independently of the strength of the Wi-Fi 124 signal, e.g., the determination of whether the CBRS cell quality is strong may not be based on a difference between the CBRS cell quality and the strength of the Wi-Fi 124 signal.

With respect to Wi-Fi eligibility, a first example condition may include whether the Wi-Fi 124 is active. As shown in FIG. 5, operation 510 determines whether the Wi-Fi 124 is active. If the Wi-Fi 124 is not active, then cellular data will be used and the CBRS network 122 will be the cellular network if the user has set the CBRS SIM as the active data SIM. A second example condition for Wi-Fi eligibility may include how a Wi-Fi network is joined, e.g., auto vs. manual. For example, if the user manually selects to join a Wi-Fi network, this may be considered to be a user preference for a particular Wi-Fi network that is honored by the SIS engine 235 by not prioritizing the CBRS network 122.

A third example condition for Wi-Fi eligibility may include how often a Wi-Fi network is used. For example, if the SIS engine 235 is aware that the UE 110 frequently connects to a particular Wi-Fi network, the SIS engine 235 may consider that the user continues to want to connect to this Wi-Fi network rather than prioritize the CBRS network 122. This frequency may be based on, for example, a threshold that has a time duration or any other manner of defining a highly used Wi-Fi network.

A fourth example condition for Wi-Fi eligibility may include whether the device is at a known home location. Again, the SIS engine 235 may consider that the user continues to want to connect to a home Wi-Fi network rather than prioritize the CBRS network 122. A fifth example condition for Wi-Fi eligibility may include whether the Wi-Fi network is a managed hotspot. Again, the SIS engine 235 may consider that a managed hotspot network offers the same advantages as the CBRS network 122 (e.g., security, throughput, etc.) such that the user continues to want to connect to the managed hotspot Wi-Fi network rather than prioritize the CBRS network 122.

Thus, the SIS engine 235 may test one or more of the above example conditions (or any other defined conditions) for Wi-Fi eligibility when making the decision to prioritize the CBRS network 122 over the Wi-Fi 124.

With respect to device eligibility, a first example condition is that the UE 110 is not in low power mode. A second example condition is that the UE 110 is not overheating. A third example condition is that the display device 225 is on and unlocked.

Those skilled in the art will understand that the above described examples of eligibility are not an exhaustive list of eligibility conditions. Other eligibility conditions may be defined and used to determine if the CBRS network 122 is to be prioritized over the Wi-Fi 124. In addition, as described above, while the above examples were described with reference to the CBRS network 122 being prioritized over the Wi-Fi 124 (e.g., the state transition from the armed state 320 to the outrank state 330), these conditions may also be tested when transitioning from the idle state 310 to the armed state 320. Moreover, it should also be understood that the conditions states described above are not the only manner of biasing the condition. For example, while it was described above that a managed hotspot was a condition that is biased toward using a Wi-Fi network rather than prioritizing the CBRS network 122, it is also possible to define the condition that a managed hotspot is a condition that is biased toward prioritizing the CBRS network 122.

Returning to FIG. 3, it is also shown that when the state engine 300 is in the outrank state 330, there may be a transition back to the idle state 310. To ensure backward compatibility, the SIS engine 235 will continue to monitor the conditions for outrank for prioritizing the CBRS network 122. Exiting from the outrank state 330 may occur when the CBRS network is no longer active, e.g., the UE 110 has left the coverage area of the CBRS network 122, the CBRS network 122 is unavailable for connection, etc. Other manners of exiting the outrank state 330 may be based on the failure to satisfy other eligibility conditions such as those described above.

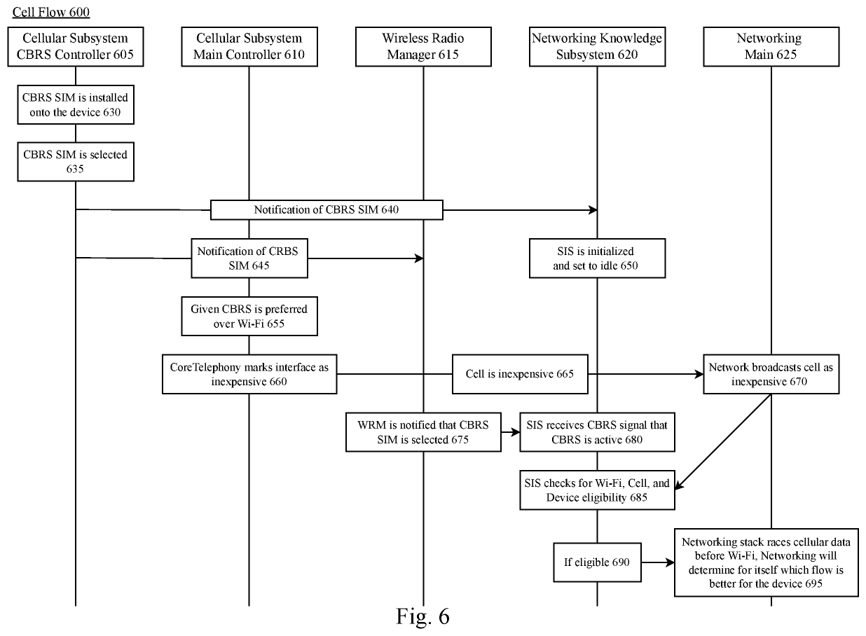

FIG. 6 shows an exemplary call flow 600 for the state engine 300 implemented by the SIS engine 235 to enter the outrank state 330 according to various exemplary embodiments. It should be understood that while this figure is labeled a call flow, the entirety of the call flow 600 occurs within the UE 110. That is, each of the components described in the call flow are implemented by the UE 110 as either a hardware component or a software component being executed by the UE 110. These components include a cellular subsystem CBRS controller 605, a cellular subsystem main controller 610, a wireless radio manager 615, a networking knowledge subsystem 620 and a networking main controller 625.

In 630, the cellular subsystem CBRS controller 605 verifies that the CBRS SIM is installed in the UE 110. In 635, the cellular subsystem CBRS controller 605 verifies that the CBRS SIM is selected as the active data cellular SIM, e.g., that the user desires to use the CBRS network 122 for cellular data, when available. In 640, the cellular subsystem CBRS controller 605 notifies the networking knowledge subsystem 620 that the two conditions of 630 and 635 are satisfied. This allows the networking knowledge subsystem 620 to instantiate 650 the SIS engine 235 and the state is set to the idle state 310, e.g., as described above if the two conditions of 630 and 635 are not satisfied, there is no reason to instantiate the SIS engine 235 because the UE 110 cannot access the CBRS network 122.

In 645, the cellular subsystem CBRS controller 605 notifies the wireless radio manager 615 that the CBRS SIM is available. In 655, the cellular subsystem main controller 610 is made aware of the user preference that the CBRS network 122 is preferred over the Wi-Fi 124. The cellular subsystem main controller 610 knows of the preference and then, in 660, marks the CBRS cellular data as inexpensive. This information is then shared, in 665, with the networking main controller 625. The networking main controller 625 will then share this information, e.g., the CBRS cellular data is marked as inexpensive, with the networking knowledge subsystem 620 in 670. The use of this information is described below with reference to 685.

In 675, the wireless radio manager 615 is notified that the CBRS SIM has been selected as the active data cellular SIM, when available. In 680, the networking knowledge subsystem 620 is notified that the CBRS network 122 is active, e.g., the UE 110 is in the coverage area of the CBRS network and all the conditions for transitioning the state engine 300 from the idle state 310 to the armed state 320 have been satisfied.

In 685, the networking knowledge subsystem 620 via the SIS engine 235 monitors all the conditions for transitioning the state engine 300 from the armed state 320 to the outrank state 330, e.g., to prioritize the CBRS network 122 over the Wi-Fi 124. As described above, part of these conditions may be whether the CBRS cellular data is inexpensive. This information is shared with the networking knowledge subsystem 620 from the networking main controller 625 in 670. The other conditions that are monitored for determining the transition between states may include the cell eligibility, Wi-Fi eligibility and device eligibility conditions for which examples were provided above.

If all the conditions for transitioning from the armed state 320 to the outrank state 330 are satisfied in 690, the networking knowledge subsystem 620 informs the networking main controller 625 and the networking main controller 625, in 695, may implement the network stack for the CBRS network 122 allowing the UE 110 to connect to the CBRS network 122.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, WatchOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to:
determine that a private enterprise deployed cellular network is available;
determine that a Wi-Fi network is available at a same time as the private enterprise deployed cellular network; and
prioritize connection to the private enterprise deployed cellular network over the Wi-Fi network based on one or more conditions.

2. The processor of claim 1, wherein the processor is further configured to:
connect to the private enterprise deployed cellular network based on the prioritization.

3. The processor of claim 1, wherein the processor is further configured to:
determine that the UE is capable of connecting to a private enterprise deployed cellular network providing cellular services.

4. The processor of claim 3, wherein the determination that the UE is capable of connecting to the private enterprise deployed cellular network comprises the processor configured to:
determine that the UE comprises a subscriber identity module (SIM) card comprising credentials to connect to the private enterprise deployed cellular network.

5. The processor of claim 1, wherein the private enterprise deployed cellular network is prioritized when the private enterprise deployed cellular network is a preferred cellular data provider.

6. The processor of claim 1, wherein the private enterprise deployed cellular network is prioritized when a user preference allows cellular data to be used for an application.

7. The processor of claim 1, wherein one condition of the one or more conditions comprises that cellular data for the private enterprise deployed cellular network is marked as inexpensive.

8. The processor of claim 7, wherein an expense flag is used to mark the private enterprise deployed cellular network as inexpensive.

9. The processor of claim 1, wherein one condition of the one or more conditions comprises whether the signal quality with the private enterprise deployed cellular network satisfies predetermined thresholds.

10. The processor of claim 1, wherein one condition of the one or more conditions comprises the UE is not in low power mode.

11. The processor of claim 1, wherein one condition of the one or more conditions comprises the UE is not overheating.

12. The processor of claim 1, wherein one condition of the one or more conditions comprises a display device of the UE is on and unlocked.

13. The processor of claim 1, wherein the private enterprise deployed cellular network is a Citizens Broadband Radio Service (CBRS) network.

14. A user equipment (UE), comprising:
a transceiver configured to communicate with one or more networks; and
a processor communicatively coupled to the transceiver and configured to:
determine that a private enterprise deployed cellular network is available;
determine that a Wi-Fi network is available at a same time as the private enterprise deployed cellular network; and
prioritize connection to the private enterprise deployed cellular network over the Wi-Fi network based on one or more conditions.

15. The UE of claim 14, wherein the processor is further configured to:
determine that the UE is capable of connecting to a private enterprise deployed cellular network providing cellular services.

16. The UE of claim 15, wherein the determination that the UE is capable of connecting to the private enterprise deployed cellular network comprises the processor configured to:
determine that the UE comprises a subscriber identity module (SIM) card comprising credentials to connect to the private enterprise deployed cellular network.

17. The UE of claim 14, wherein the private enterprise deployed cellular network is prioritized when the private enterprise deployed cellular network is a preferred cellular data provider.

18. The UE of claim 14, wherein the private enterprise deployed cellular network is prioritized when a user preference allows cellular data to be used for an application.

19. The UE of claim 14, wherein one condition of the one or more conditions comprises that cellular data for the private enterprise deployed cellular network is marked as inexpensive.

20. The UE of claim 14, wherein one condition of the one or more conditions comprises one of (i) whether the signal quality with the private enterprise deployed cellular network satisfies predetermined thresholds, (ii) the UE is not in low power mode, (iii) the UE is not overheating or (iv) a display device of the UE is on and unlocked.
